(19) United States
(12) Patent Application Publication
(10) Pub. No.: US 2004/0239190 A1
(43) Pub. Date: Dec. 2, 2004

(54) Stator lamination packet

(76) Inventors: Eberhard Rau, Korntal-Muenchingen (DE); Martin Henne, Moeglingen (DE); Klaus Pflueger, Eberdingen (DE)

Correspondence Address: Striker Striker & Stenby, 103 East Neck Road, Huntington, NY, 11743, US

(21) Appl. No.: 10/491,091

(22) PCT Filed: Sep. 19, 2003
(86) PCT No.: PCT/DE03/03133

(30) Foreign Application Priority Data
Sep. 20, 2002 (DE) 102 43 985.0

(51) Int. Cl. H02K 1/00

(52) U.S. Cl. 310/10

(57) ABSTRACT

A stator lamination packet for an electrical machine is proposed which comprises individual stacked striplike laminations (10). This stator lamination packet (29) has one side (E) provided with teeth (15) and slots (16), which in at least one slot base (22) has at least one weld seam (24) for fixing the stacked laminations (10).

### PRIOR ART

The invention relates to a stator lamination packet in accordance with the characteristics of the independent claim. From German Patent Disclosure DE-OS 4421399, a stator lamination packet is known which comprises a plurality of individual laminations that when put together or put in a packet form the stator core. To create an economically produced, high-precision stator core for an electrical machine, the faces of the teeth oriented radially inward are joined by means of a weld seam.

From Japanese Patent Disclosure JP 9-103052, a stator lamination packet is known which comprises a plurality of striplike laminations. After the laminations have been put into a packet and a stator winding has been placed around them, the assembled unit comprising the stator lamination packet and the winding is bent to form a round stator. As a result, the radially inward-oriented teeth of the individual laminations, particularly of the laminations located axially on the outside, may protrude somewhat in the axial direction.

### ADVANTAGES OF THE INVENTION

The round stator lamination packet of the invention having the characteristics of the main claim has the advantage that by means of the at least one weld seam in a slot base, on the one hand the stacked laminations are fixed, and on the other, spreading apart of the radially inward-oriented teeth of the stator lamination packet bent into a round shape is largely averted. By the provisions recited in the dependent claims, advantageous refinements of the stator lamination packet of the main claim are possible. An especially favorable disposition of a plurality of weld seams is attained if a plurality of weld seams are disposed at a spacing from one another which is essentially equivalent to a periodicity of 2 times τₚ. Different pole fluxes caused by magnetic asymmetries (nonhomogeneity of materials, geometric asymmetries, manufacturing tolerances, errors in assembly, etc.) in the path of the main flux generate a compensatory flux, which in the winding, comprising laminations (which are each a tangential part of the winding) and the welded connection (each an axial part of the winding) induces a voltage which in this winding can in turn drive a circulating current that puts a thermal load on the electrical machine. This circulating current can be minimized by the periodicity of 2 times τₚ.

Particularly in connection with rotary current machines for use in motor vehicles, it is provided that the spacing of at least two weld seams is equivalent to six teeth and in addition a tolerance of at maximum two teeth. Such an arrangement offers the advantages that on the one hand, for the essentially 12-pole (corresponding to 36- and 72-slot) to 16-pole (corresponding to 48- and 96-slot) versions, the aforementioned periodicity of 2 times τₚ is attained, and on the other the stator lamination packets, because of their structural volume associated with these pole teeth, are held together mechanically securely.

In a further feature of the invention, it is provided that on both sides of a butt joint, at which at least two ends of at least one striplike lamination contact one another, one weld seam in each respective next slot joins a plurality of laminations to one another. If the initially striplike stator lamination packet is welded at precisely this first or last slot of the stator lamination packet, then the substantial advantage is attained that the initially striplike lamination packet, at each of its face ends, does not “unravel” and come apart, and thus a high-quality butt joint with high dimensional accuracy is obtained. A further improvement in the stator lamination packet is obtained especially whenever once again on both sides of the butt joint, one weld seam each joins a plurality of laminations on an outside, that is, on the side of the stator lamination packet that is placed opposite the dynamo-electrically operative teeth.

A further improvement to the stator lamination packet is obtained whenever in the butt joint, at least one weld seam is made on the outside. In operation, the butt joint is a weak point, so that the stator teeth, subject here to magnetic flux, and the stator lamination packet intrinsically tend to vibration, which can be reduced by means of a corresponding weld seam on the outside. The same advantages are obtained with respect to a weld seam on the inside of the butt joint.

Further advantages are obtained if at least two weld seams are made on the outer circumference, disposed at a spacing from one another which is essentially equivalent to a periodicity of 2 times τₚ. The advantages of this arrangement are once again the aforementioned minimization of the circulating currents that put a thermal load on the electrical machine.

### DRAWINGS

The drawings show exemplary embodiments of a stator lamination packet of the invention.

Shown are:

FIGS. 1a through 1e, in principle, a production process in accordance with the invention described here;

FIG. 2, a first exemplary embodiment of a stator lamination packet, with 36 slots;

FIG. 3, a second exemplary embodiment of a stator lamination packet, with 48 slots;

FIG. 4, a third exemplary embodiment of a stator lamination packet, with 48 slots;

FIG. 5, a fourth exemplary embodiment of a stator lamination packet, with 48 slots and middle laminations of enlarged diameter;

FIG. 6, a fifth exemplary embodiment of a stator lamination packet in a modification of the exemplary embodiment of FIG. 5;

FIG. 7, a fragmentary view of a slot with two weld seams in the slot base.

### DESCRIPTION

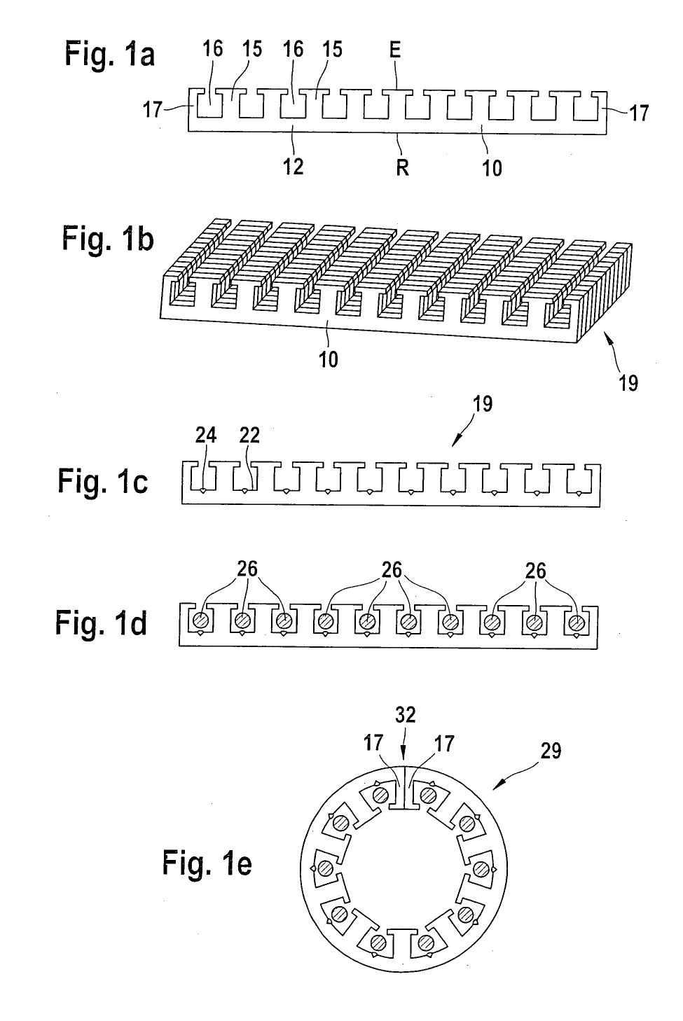

In FIGS. 1a through 1e, the method of the invention for producing the stator lamination packet of the invention is shown in principle.

FIG. 1a shows an individual striplike lamination 10, which has a back side R on one side and an electrically operative side E. The back side comprises a continuous yoke part 12, from which individual teeth 15 extend integrally in the direction of the electromagnetically operative side E. Between the teeth 15, slots 16 are provided. The striplike lamination 10 has two ends, and an end tooth 17 is disposed on each end. The shape of the striplike lamination 10 is not limited to a rectilinear shape as shown in FIGS. 1a through 1e; instead, it can for instance have a curved shape, such as a bow shape, in which case the yoke part 12 is not rectilinear. A plurality of laminations 10 are put together into a packet in a further method step in such a way that all the teeth 15 and slots 16 rest congruently one above the other; see also FIG. 1b. The laminations 10 put together into a packet now form a laminated strip packet 19. In the stator lamination packet of the invention, it is provided that in a further method step, a weld seam 24 for fixing the stacked laminations 10 is made in at least one slot base 22. In the example shown in FIG. 1c, one weld seam 24 is made in each slot base 22. In a further method step shown in FIG. 1d, the fixed laminated strip packet 19 is equipped with a winding 26 shown in symbolic form. The conductor elements shown symbolically are disposed entirely inside the slots 16. In a further method step shown in FIG. 1e, the now preassembled, laminated strip packet 19, with the winding 26, is finally reshaped in such a way that an annular stator lamination packet 29 is created. In a further method step, not shown, it is conventionally provided that the stator lamination packet 29 is joined, for instance by welding, at a joining point 32. The joining point 32 is created as a result of the fact that the end teeth 17 abut another there.

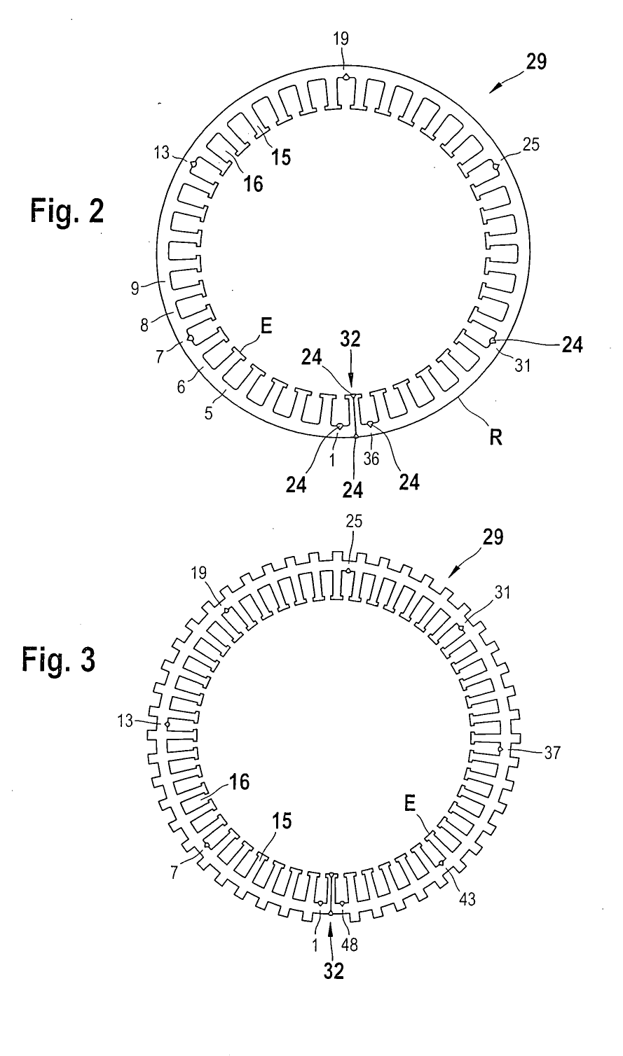

In FIG. 2, as in the drawings that follow, the stator lamination packet 29 is shown in simplified form without the winding 26, although in the round state a winding 26 is certainly present. FIG. 2 shows a stator lamination packet 29 with a total of 36 slots 16 and 36 teeth 15. This stator lamination packet 29 is intended for a 12-pole rotary current machine. In the exemplary embodiment described here, a plurality of weld seams 24 are provided, which are disposed at a specified spacing from one another. A first weld seam 24 is drawn or made in the slot 16 marked with the position numeral 1. Further weld seams 24 are positioned in the slots 16 designated by the position numerals 7, 13, 19, 25 and 31. The spacings between the weld seams 24 in the slots 16 having the position numerals 1, 7, 13, 19, 25 and 21 are spaced apart from each respective next one—with the exception of the weld seam 24 in the slot 36—that is precisely equivalent to twice the pole spacing. This spacing can also be expressed by saying that the spacing for instance from the weld seam 24 in the slot 16 having the position numeral 1 and the weld seam 24 in the slot 16 having the position numeral 7 amounts to twice a pole pitch τₚ. The magnitude τₚ is equivalent to the pole pitch. For reasons of strength, it is not absolutely necessary for the spacing between two weld seams 24 to correspond to twice one pole pitch τₚ. With respect to the weld seams 24 in the slots 16 having the position numerals 1, 7 and 13, the weld seam 24 provided in the slot 16 with the position numeral 7, for instance, can also be displaced by a maximum of ±2 slots, so that the weld seam 24 which was formerly made in the slot having the position numeral 7 can also be disposed in the slots 16 having the position numerals 5, 6, 8 or 9. This is analogously true for the weld seams around the slots 16 having the position numerals 13, 19, 25 and 31. The weld seam 24 in the slot 16 having the position numeral 36 is somewhat of an exception. This weld seam 24 intrinsically serves to hold the stator lamination packet 29 together at the ends of the laminated strip packet 13 before it is bent into a round shape; see also FIGS. 1c and 1e. As a result, at the butt joint 32 where at least two ends of at least one striplike lamination 10 contact one another, in each next slot 16 on both sides of the butt joint 32, in this case the slots 16 having the position numerals 1 and 36, a plurality of laminations 10 are joined together. It is furthermore provided that in the butt joint 32, at least one weld seam 24 is made on the outside, in this case on the side R of the stator lamination packet 29. The same is true for the radial inside of the joining point 32, so that at the butt joint 32, at least one weld seam 24 is made on the inside—the electromagnetically operative side E.

In the exemplary embodiment of FIG. 3, a stator lamination packet 29 for a rotary current machine is provided that has a total of 16 poles. Accordingly, on its radial inside E, the stator lamination packet 29 has a total of 48 teeth 15 and 48 slots 16. Once again, the same prescribed layout as already mentioned is employed, so that once again weld seams 24 are made in the slots 1, 7, 13, 19, 25, 31, 37 and 43. Also, as in the previous exemplary embodiment, there is one weld seam 24 made in each slot 16, or slot base 22, that is closest to the butt joint 32. In that case, a weld seam 24 is likewise made in the slot 16 at the position numeral 48.

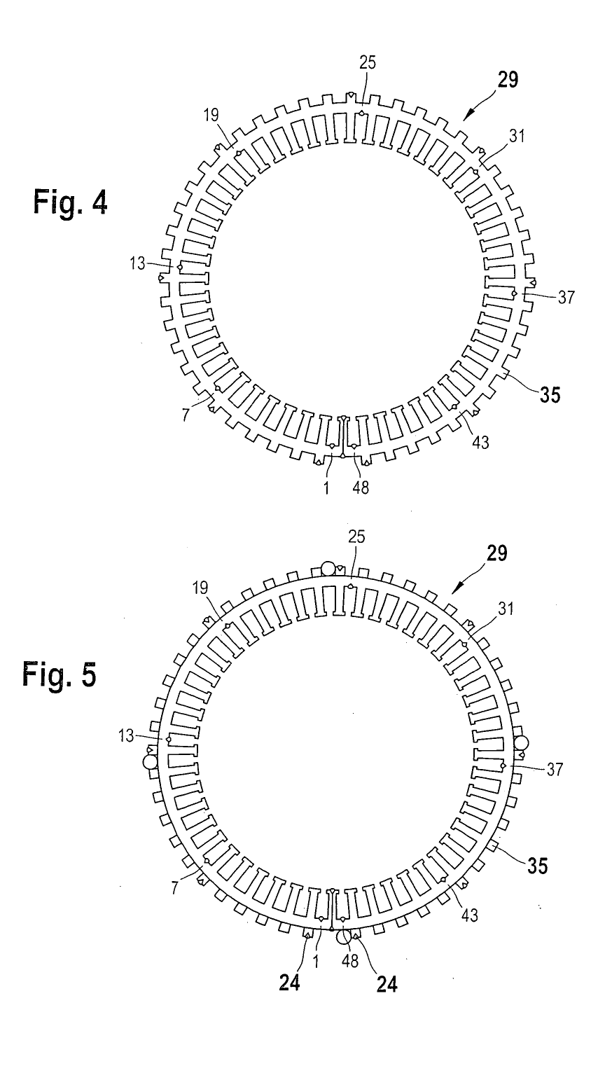

In the exemplary embodiment of FIG. 4, the same stator lamination packet 29 as in FIG. 3 is shown. In a distinction from the exemplary embodiment of FIG. 3, outer teeth 35 each have one weld seam 24. The weld seams 24 on the outer teeth 35 are disposed such that these weld seams 24 are made on those outer teeth 35 that are each closest to the respective slots 16 having the position numerals 1, 7, 13, 19, 25, 31, 37, 43 and 48. Accordingly, it is provided that one weld seam 24 on each side of the butt joint 32 joins a plurality of laminations 10 together on an outside R.

The exemplary embodiment of FIG. 5 shows a modification of the exemplary embodiments of FIG. 3 and FIG. 4. This stator lamination packet 29 comprises different laminations 10. Approximately in the middle of the stator lamination packet 29, that is, the axial center, there are laminations 10 with outer teeth 35, and on both sides of these center laminations 10 there are laminations 10 without outer teeth 35. In this case, only the center laminations 10 with the outer teeth 35, at the points described for the exemplary embodiment of FIG. 4, have weld seams 24. The weld seams 24 on the outer teeth 35—see FIG. 4 and FIG. 5—are furthermore disposed on the outer teeth 35 so that the resultant microstructural changes are kept as far away from the yoke part 12 as possible.

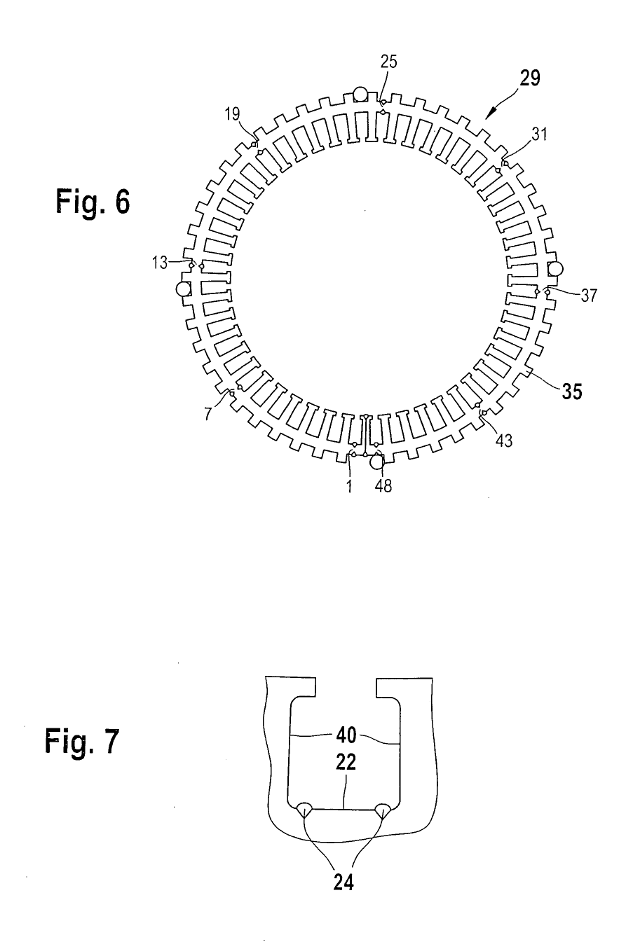

In FIG. 6, a further exemplary embodiment, in a modification of the exemplary embodiment of FIG. 5, is shown. The weld seams 24 on the inside E of the stator lamination packet 29 are, as in the exemplary embodiments of FIGS. 3, 4 and 5, made at the positions 1, 7, 13, 19, 25, 31, 37 and 43 of the slots 16, and finally at the position 48 as well. In a modification of the foregoing exemplary embodiments, the weld seams 24 are made on the outside R, radially opposite the aforementioned weld seams 24 on the inside of the stator lamination packet 29. For the weld seams 24 on the outer teeth 35 and on the outside R of the stator lamination packet 29, it is equally true that a spacing between the outer weld seams 24 is essentially equivalent to a periodicity of 2 times τₚ. For the weld seams 24 on the outside R as well it is true that here a tolerance of a maximum of two teeth 15 is allowable.

In FIG. 7, a further exemplary embodiment of an arrangement of weld seams 24 on the stator lamination packet 29 is shown. To further prevent the stator lamination packet 29 from spreading apart as it is bent into a round shape, it is provided that the slot 16 for which a weld seam 24 is provided at all has two weld seams 24, which are disposed at a position where the slot base 22 merges with a tooth flank. For this kind of paired disposition of weld seams 24 in the slot base 22 as well, the same layout rules mentioned above also apply. This means that where before one weld seam 24 was provided and now two weld seams 24 are provided, the pairs of weld seams 24 are treated in design terms like a single weld seam.

1. A stator lamination packet (29) for an electrical machine, which packet comprises individual stacked striplike laminations (10), wherein this stator lamination packet (29) has one side (E) provided with teeth (15) and slots (16), and at least one weld seam (24) for fixing the stacked laminations (10) is made in at least one slot base (22).

2. The stator lamination packet of claim 1, wherein a plurality of weld seams (24) are disposed at a spacing from one another which is essentially equivalent to a periodicity of 2 times τₚ.

3. The stator lamination packet of claim 1, wherein the spacing of at least two weld seams (24) is equivalent to six teeth (15) and in addition a tolerance of at maximum two teeth (15).

4. The stator lamination packet of claim 1, having an butt joint (32), at which at least two ends of at least one striplike lamination (10) contact one another, wherein on both sides of the butt joint (32) in the respective next slot (16), one weld seam (24) each joins a plurality of laminations (10) to one another.

5. The stator lamination packet of claim 1, having a butt joint (32), at which at least two ends of at least one striplike lamination (10) contact one another, wherein on both sides of the butt joint (32) in the respective next slot (16), one weld seam (24) each joins a plurality of laminations (10) on an outside (R) to one another.

6. The stator lamination packet of claim 4, wherein in the butt joint (32), at least one weld seam (24) is made on the outside (R).

7. The stator lamination packet of claim 4, wherein in the butt joint (32), at least one weld seam (24) is made on the inside (E).

8. The stator lamination packet of claim 1, wherein at least two weld seams (24) are made on the outer circumference, disposed at a spacing from one another which is essentially equivalent to a periodicity of 2 times τₚ.
